(19) United States
(12) Patent Application Publication
(10) Pub. No.: US 2005/0192729 A1
(43) Pub. Date: Sep. 1, 2005

(54) Method for calculating a wheel angle of a vehicle

(76) Inventors: Wolfgang Reinelt, Stuttgart (DE); Willy Klier, Schwaebisch Gmuend (DE); Reinhard Grossheim, Boebingen (DE)

Correspondence Address: JORDAN AND HAMBURG LLP, 122 EAST 42ND STREET, SUITE 4000, NEW YORK, NY, 10168, US

(21) Appl. No.: 10/999,446

(22) Filed: Nov. 29, 2004

(30) Foreign Application Priority Data
Feb. 28, 2004 (DE) 10 2004 009 823.9

(51) Int. Cl. B62D 6/00

(52) U.S. Cl. 701/41; 180/408

(57) ABSTRACT

A method for calculating a wheel angle, especially that of a steerable wheel on the inside curve by means of an analytical relationship in accordance with the vehicle geometry, the wheel base, track width and wheel speeds being used for the calculation.

### BACKGROUND OF THE INVENTION

The invention relates to a method for calculating a wheel angle, especially that of a steerable wheel of a vehicle on the inside curve. The invention also relates to a method for calculating the speed of a vehicle and to a method for plausibilizing a pinion angle in a superimposed steering.

For active steering systems, such as those know from DE 197 51 125 A1, the steering movements, brought about by the driver by mans of a steering wheel, the steeling angles, angles detected by a sensor, are superimposed by means of a superimposition gear on the motor angle with the movements of the actuator driving mechanism. The sum of these angles, the pinion angle, is passed on over the steering mechanism or the steering linkage to the steerable wheels for adjusting the steering angle. The adjusted pinion angle can be retrieved as a signal over a special sensor. Moreover, this pinion angle must be monitored or plausibilized or optionally calculated separately in model. With the help of the wheel speeds, for example, this can be done using the so-called Ackermann equation, which, however, is not valid in dynamic driving situations.

DE 185 37 791 A1 discloses a method and a device for determining the speed of a motor vehicle. For this purpose, the rotational speed of the individual wheels is determined and recalculated into the speed of the vehicle. In addition, for the steered wheels, the wheel angle is included by making use of the steering wheel angle and a steering ratio. This is not conceivable for active steering systems, since additionally a motor angle of the actuator must be supplied over the superimposition gear and, accordingly, conclusions concerning the wheel angle cannot be drawn directly from the steering wheel angle and the steering ratio. Too many measurement signals would have to be taken into consideration, which would be expensive to plausibilize previously.

### SUMMARY OF THE INVENTION

It is therefore an object of the present invention to provide a method for calculating a wheel angle, which makes do with the fewest possible measurement signals and works reliably also in dynamic driving situations.

Through these measures, a method for calculating the wheel angle of a vehicle, which makes a reliable calculation possible independently only by using the wheel velocities, is created in a simple and advantageous manner. With the help of the angle so calculated, a conclusion can be reached concerning the actual speed of the vehicle in the steered direction.

Moreover, by means of this angle, a pinion angle of a steering system can be calculated independently or a pinion angle sensor can be plausibilized.

In the following, an example of the invention is described in principle by means of the drawings.

### BRIEF DESCRIPTION OF THE DRAWINGS

FIG. 1 shows an diagrammatic view of a theoretically stationary circular trip of a vehicle, and

FIGS. 2 and 3 show a diagrammatic view of the steering system of the state of the art which represents the starting point for the inventive example.

### DESCRIPTION OF THE PREFERRED EMBODIMENTS

The calculation of an angle of a wheel is shown in the following by way of example by means of my means of a steerable wheel of a vehicle on the inside of the curve.

Based on the actual wheel speeds, the radii of the circular paths, which arise during a stationary circular trip of a vehicle, are calculated. An equation relating the time required for the stationary circular trip to the speed of the two front wheels is then set up. By inserting the equations in one another, it is possible to represent the angle of the front wheel on the inside curve as a function of the speeds of the two front wheels.

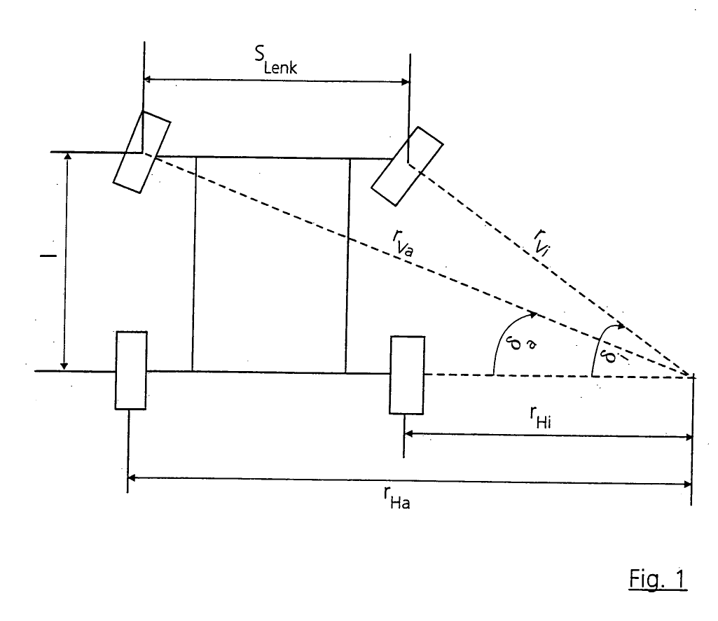

In FIG. 1, a stationary circular trip of a vehicle is shown, in which:
δ₁ represents an angle of a front wheel on the inside curve
δ₂ represents an angle of a front wheel on the outside curve
r_{Vi} represents the actual radius of the circular path of a front wheel on the inside curve'
r_{Va} represents the actual radius of the circular path of a front wheel on the outside curve,
r_{Hi} represents the actual radius of the circular path of a rear wheel on the inside curve
r_{Ha} represents the actual radius of the circular path of a rear wheel on the outside curve
S_{Lenk} represents the track width
I represents the wheel base and
ω_{vi,a} represents wheel speeds.

The following equation can be derived from FIG. 1:

$$\begin{matrix}{r}_{Vi} = \frac{I}{sin {δ}_{i}} , \\ {r}_{Hi} = cos {δ}_{i} \cdot {r}_{Vi} = \frac{cos {δ}_{i} \cdot I}{sin {δ}_{i}} or \\ {r}_{Va} = \sqrt{{I}^{2} \cdot \frac{1}{{tan}^{2} {δ}_{i}} + 2 \cdot I \cdot {S}_{Lenk} \cdot \frac{1}{tan {δ}_{i}} + ( {S}_{Lenk}^{2} + {I}^{2} )} .\end{matrix} \qquad ( 1.1 )$$

In the case of a stationary, circular trip, the speed of the wheels is calculated from the circumference of the circle, divided by the time required. The time required is the same for all four wheels.

For the front wheel, at the inside of the curve:

$${ω}_{Vi} = \frac{2 \cdot π \cdot {r}_{Vi}}{Δ t} . \qquad ( 1.2 )$$

Furthermore,

$${r}_{Vi}^{2} = ( {I}^{2} \cdot ( 1 + \frac{1}{{tan}^{2} {δ}_{i}} ) ) . \qquad ( 1.3 )$$

Squaring (1.2),

$${ω}_{Vi}^{2} = \frac{4 \cdot {π}^{2} \cdot {r}_{Vi}^{2}}{{Δ}^{2} {t}^{2}} . \qquad ( 1.4 )$$

If (1.3) is inserted in (1.4),

$${ω}_{Vi}^{2} = \frac{4 \cdot {π}^{2} \cdot {I}^{2} \cdot ( 1 + \frac{1}{{tan}^{2} {δ}_{i}} )}{{Δ}^{2} {t}^{2}} . \qquad ( 1.5 )$$

Correspondingly, for the squared velocity of the front wheel on the outside curve:

$${ω}_{Va}^{2} = \frac{\begin{matrix}4 \cdot {π}^{2} \cdot ( {I}^{2} \cdot \frac{1}{{tan}^{2} {δ}_{i}} + 2 \cdot I \cdot {S}_{Lenk} \cdot \\ \frac{1}{{tan}^{2} {δ}_{i}} + ( {S}_{Lenk}^{2} + {I}^{2} ) )\end{matrix}}{{Δ}^{2} {t}^{2}} . \qquad ( 1.6 )$$

If (1.6) is rearranged,

$${Δ}^{2} {t}^{2} = \frac{4 \cdot {π}^{2} \cdot {I}^{2} \cdot ( 1 + \frac{1}{{tan}^{2} {δ}_{i}} )}{{ω}_{Vi}^{2}} . \qquad ( 1.7 )$$

If (1.7) is inserted and (1.6),

$${ω}_{Va}^{2} = \frac{\begin{matrix}4 \cdot {π}^{2} \cdot ( {I}^{2} \cdot \frac{1}{{tan}^{2} {δ}_{i}} + 2 \cdot I \cdot {S}_{Lenk} \cdot \\ \frac{1}{tan {δ}_{i}} + ( {S}_{Lenk}^{2} + {I}^{2} ) ) \cdot {ω}_{Vi}^{2}\end{matrix}}{4 \cdot {π}^{2} \cdot {I}^{2} \cdot ( 1 + \frac{1}{{tan}^{2} {δ}_{i}} )} \qquad ( 1.8 )$$

Equation (1.8) represents a quadratic equation which can be solved for 1/tan δ₁ to yield:

$$tan {δ}_{i} = \frac{- I \cdot ( {ω}_{Vi}^{2} - {ω}_{Va}^{2} )}{{S}_{Lenk} \cdot {ω}_{Vi}^{2} \pm \sqrt{{S}_{Lenk}^{2} \cdot {ω}_{Vi}^{2} \cdot {ω}_{Va}^{2} - {I}^{2} \cdot {( {ω}_{Vi}^{2} - {ω}_{Va}^{2} )}^{2}}} \qquad ( 1.9 )$$

An examination of the results shows that only the solution with a positive sign is physically meaningful. Accordingly:

$$tan {δ}_{i} = \frac{- I \cdot ( {ω}_{Vi}^{2} - {ω}_{Va}^{2} )}{{S}_{Lenk} \cdot {ω}_{Vi}^{2} + \sqrt{{S}_{Lenk}^{2} \cdot {ω}_{Vi}^{2} \cdot {ω}_{Va}^{2} - {I}^{2} \cdot {( {ω}_{Vi}^{2} - {ω}_{Va}^{2} )}^{2}}}$$

and finally,

$${δ}_{i} = arctan ( \frac{- I \cdot ( {ω}_{Vi}^{2} - {ω}_{Va}^{2} )}{{S}_{Leak} \cdot {ω}_{Vi}^{2} + \sqrt{{S}_{Leak}^{2} \cdot {ω}_{Vi}^{2} \cdot {ω}_{Va}^{2} - {I}^{2} \cdot {( {ω}_{Vi}^{2} - {ω}_{Va}^{2} )}^{2}}} ) . \qquad ( 1.10 )$$

It remains to be noted that usually the wheel on the inside curve is the slower wheel. With the calculation of the angle δ₁ of the wheel at the inside curve, the instantaneous summation angle or pinion angle δ_{G} can be deduced from a characteristic line of an inverse steering kinematics.

Accordingly, an angle δ₁ of especially a steerable wheel of a vehicle on the inside curve can be calculated easily in accordance with the vehicle geometry using an analytical relationship. In so doing, the wheelbase or axle base, track width S_{Lenk}, as well as the speed ωᵥᵢ of the wheel on the inside curve and the speed ωᵥₐ of the wheel on the outside curve are used for the calculation.

Furthermore, the speed of a vehicle vₓ can be calculated from four wheel speeds ω_{FL}, ω_{FR}, ω_{RL} and ω_{RR} of the vehicle and the above-calculated angle δᵢ of the steerable wheel of the vehicle on the inside curve. For this purpose, suitable wheel speeds ω_{FL}, ω_{FR}, ω_{RL} and ω_{RR} are selected on the basis of the states of a driving situation of the vehicle, especially skidding, drifting, wandering, ESP interventions, ABS interventions or braking interventions. As shown in the following, by way of example, for ω_{FL}, these are then multiplied by the cosine of the angle δ₁, in order to obtain the longitudinal speed ω_{XFL} (compare DE 195 37 791 A1):
ω_{XFL}=ω_{FL}·cos(δ₁).

In the following, an example is used to explain the invention with regard to the plausibilization and/or calculation of a pinion angle. By way of example, the starting point is a previously mentioned superimposed steering. Of course, the invention can also be used for other steering systems, such as steering by wire, etc. after an expansion.

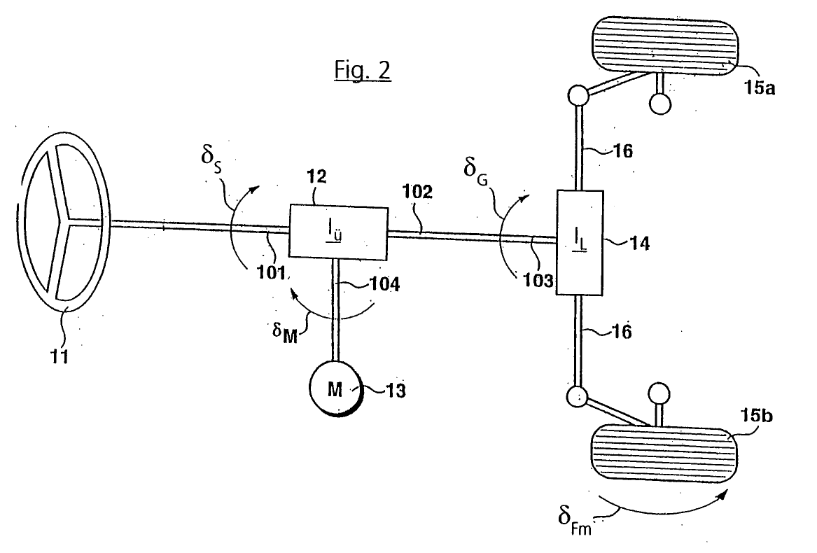

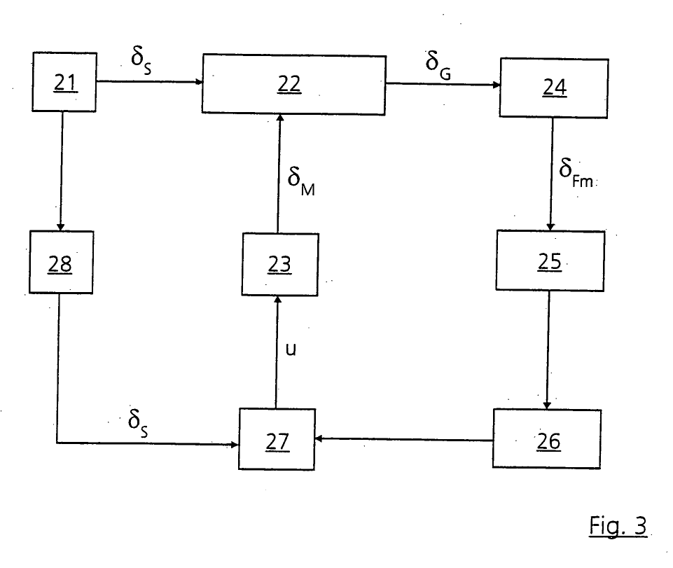

FIGS. 2 and 3, with the reference symbols 11 and 21 respectively, show a steering wheel, which can be operated by the driver of the vehicle. By operating the steering wheel 11 or 21, a steering wheel angle δₛ is supplied to a superimposition gear 12 or 22 over a connection 101. At the same time, a motor angle δ_{M} of an actuator 13 or 23 is supplied to the superimposition gear 12 or 22 over a connection 104; the actuator may be constructed as an electric motor. At the output side of the superimposition gear 12 or 22, the superimposed movement or the pinion angle δ_{G} is supplied over a connection 102, 103 to a steering mechanism 14 or 24, which, in turn, acts upon steerable wheels 15a and 15b with a steering angle δ_{Fm} according to the superimposed movement or the total angle δ_{G}. The mechanical gearing up of the superimposition gear 12 or 22 for δ_{M}=0 is labelled δ_{G}/δ_{S} and the mechanical gearing up of the steering mechanism 14 or 24 is labelled i_{L}.

A reaction moment Mᵥ, affected by the street, acts upon the wheels 15a and 15b, which are designed to be steered. Furthermore, sensors 26 and 28 can be seen in FIG. 3. Sensor 28 detects the steering wheel angle δ_{S} and supplies it to a control device 27. Sensors 26 detect the movements of the vehicle (such as the yaw movements, the transverse acceleration, the wheel speeds, the vehicle speed vₓ, etc.) and the pinion angle δ_{G}. and supply corresponding signals to the control device 27. Independently of the steering wheel angle δₛ determined and possibly depending on the movements of the vehicle, a control variable u is determined by the control device 27 for triggering the actuator 13 or 23 for realizing practical applications (such as variable gearing up of the steering). The signals of the sensors 26 can also be taken from a CAN bus system of the vehicle.

Between the angles shown in FIGS. 2 and 3, the following, well-known equation applies (i_{L} is a nonlinear function):
i_{L}(δ_{Fm})=[δ_{S}/i₀+δ_{M}] (2)

Because of the safety requirements that must be met by a steering system, a safety concept with safety functions and diagnostic functions is indispensable, especially for discovering accidental errors in the sensors 26, 28, the control device 27 itself or the actuator system and for reacting suitably, that is, for example, to switch the practical applications, especially the variable steering ratio, suitably and/or to start appropriate substitute modes. The input signals of the control device 27, especially δ_{S} and δ_{G}, and the vehicle-specific data of the sensors 26 are checked continuously for plausibility. For example, it would be disadvantageous to accept a wrong speed signal vₓ of the vehicle, since the variable steering ratio is varied depending on the speed. The method for operating the steering system is realized as a computer program on the control device 27.

For plausibilizing the pinion angle input signal or for calculating the pinion angle δ_{G}, the angle δ₁ of the wheel of the vehicle can now be determined, as explained above, by means of the relationship (1.10), by means of which the pinion angle δ_{G} can be deduced from the angle δ₁ of the steerable wheel on the inside curve by means of a specified steering geometry.

Moreover, it is advantageous if states of a driving situation of the vehicle, especially drifting, wandering, ESP interventions, ABS interventions or other braking interventions are taken into consideration for the plausibilization of the pinion angle input signal and/or for the calculation of the pinion angle δ_{G}.

### REFERENCE SYMBOLS

11 steering wheel

12 superimposition gear

13 actuator

14 steering gear

15a wheels

15b wheels

16 steering linkage

21 steering wheel

22 superimposition gear

23 actuator

24 steering gear

25 -

26 sensors

27 control device

28 sensors

101 connection

102 connection

103 connection

104 connection

δ_{S} steering wheel angle

δ_{M} motor angle

δ_{G} pinion angle

δ_{Fm} steering angle

vₓ vehicle speed

iₛ mechanical gearing up of the superimposition gear

i_{L} mechanical gearing up of the steering gear

δ₁ angle of a front wheel at the inner curve

δₐ angle of a front wheel at the outer curve

r_{Vi} actual radius of the circular path of a front wheel at the inner curve

r_{Va} actual radius of the circular path of a front wheel at the outer curve

r_{Si} actual radius of the circular path of a rear wheel at the inner curve

r_{Ha} actual radius of the circular path of a rear wheel at the outer curve

s_{Lenk} track width

I wheel base

ω_{FL} speed of a left front wheel

ω_{FR} speed of right front wheel

ω_{RL} speed of left rear wheel

ω_{RR} speed of right rear wheel

1. Method for calculating a wheel angle (δ₁), especially that of a steerable wheel on the inside curve my means of an analytical relationship in accordance with the vehicle geometry, the wheel base (I), track width (S_{Lenk}) and wheel speeds (ω_{vi,a}) being linked in the manner shown below
$${δ}_{i} = arctan ( \frac{- I \cdot ( {ω}_{Vi}^{2} - {ω}_{Va}^{2} )}{{S}_{Leak} \cdot {ω}_{Vi}^{2} + \sqrt{{S}_{Leak}^{2} \cdot {ω}_{Vi}^{2} \cdot {ω}_{Va}^{2} - {I}^{2} \cdot {( {ω}_{Vi}^{2} - {ω}_{Va}^{2} )}^{2}}} )$$
wherein
δ₁ is the angle of a front wheel on the inside curve
S_{Lenk} is the track width
I is the axle base of the vehicle and
ωᵥᵢ is the wheel velocity of the front, inner, steered wheel
ωᵥₛ is the wheel velocity of the front, outer steered wheel
of the vehicle.

2. Method for operating a steering system of a vehicle with at least one steerable wheel, an actuator and a superimposition gear, the steering movement (δₛ), initiated by the driver, and the movements (δ_{M}) initiated by the actuator for producing the steering movement of the steerable wheel (δ_{Fm}) being superimposed by the superimposition gear into a pinion angle (δ_{G}) for realizing practical applications, the actuator being triggered for initiating the movement (δ_{M}) of a control device by a control signal (u) of a control device, the control device maintaining the steering wheel angle (δ_{S}), the pinion angle (δ_{G}) and further vehicle-specific parameters, especially the vehicle speed (vₓ) as input signals for determining the control signal (u) a wheel angle (δᵢ), especially of a steerable wheel of the vehicle at the inner curve, being determined by the method of claim 1 for plausibilizing the pinion angle input signal or for calculating the pinion angle (δ_{G}), after which the pinion angle (δ_{G}) is deduced from the wheel angle (δᵢ) by means of a specified steering geometry.

3. The method of claim 2, wherein states of a driving situation of the vehicle, especially skidding, drifting, wandering, ESP interventions, ABS interventions or braking interventions, are taken into consideration during the plausibilization of the pinion angle input signal and/or during the calculation of the pinion angle (δ_{G}).

4. The method of claim 1, wherein using a selection and/or weighting of the wheel speeds (ω_{FL}, ω_{FR}, ω_{RL}, ω_{RR}), the wheel angle (δi) is included for calculating the vehicle speed (vₓ).

5. Computer program with program coding means, in order to carry out the method of claims 2 or 3, when the program is executed on a computer, especially on the control device of the steering system.

6. Control device for a steering system for carrying out the computer program of claim 5.
